(19) United States
(12) Patent Application Publication
(10) Pub. No.: US 2025/0129867 A1
(43) Pub. Date: Apr. 24, 2025

(54) QUICK DISCONNECT COUPLING ASSEMBLY

(71) Applicant: Eaton Intelligent Power Limited, Dublin 4 (IE)

(72) Inventors: Nipen Mukeshbhai Khirsaria, Pune (IN); Dipak B. RANAWARE, Hadapsar (IN); Jochen MEIDLEIN, Munich (DE)

(21) Appl. No.: 18/919,551

(22) Filed: Oct. 18, 2024

(30) Foreign Application Priority Data
Oct. 20, 2023 (IN) 202311071944

(51) Int. Cl. F16L 37/40

(52) U.S. Cl. CPC F16L 37/40

(57) ABSTRACT

The present disclosure relates a quick disconnect coupling assembly having a collar inserted through an internal valve seat to be joined to a valve member and form a seal with the internal valve seat. The assembly having a valve guide positioned within the flow passage, a valve member supported by the valve guide within the valve housing, and a collar mounted to a valve head of the valve member.

### CROSS-REFERENCE TO RELATED APPLICATION

This application claims the benefit of and priority to Indian Provisional Application No. 202311071944, filed Oct. 20, 2023, which is hereby incorporated herein by reference. To the extent appropriate, a claim of priority is made to the above-disclosed application.

### TECHNICAL FIELD

The present device pertains to the technical field of quick disconnect coupling assemblies.

### BACKGROUND

Quick disconnect coupling assemblies are commonly used in fluid flow systems to allow flow. Quick disconnect coupling assemblies often require numerous components to allow for assembly of the poppet valve within the flow passage. This may lead to disadvantages such as complex assembly, higher weight, and pressure drop. When assembling a valve within a valve housing which is already complete, physical limitations such as the diameter of the valve seat and the diameter of the poppet valve may make assembly difficult.

### SUMMARY

One aspect of the present disclosure relates to a coupling assembly configured to allow a valve member to be loaded into a valve housing of the valve through a port of the valve housing (e.g., a first port or second port of the valve housing). After the valve member has been loaded into the housing, a sealing collar can be loaded into the housing through the port and the valve seat and installed on the valve member such that the sealing collar is carried with the valve member as the valve member moves between open and closed positions. Once the sealing collar is installed on the valve member, the valve member is prevented by the sealing collar from exiting the valve through the valve seat. The sealing collar can include a seal that provides sealing (e.g., radial sealing) with respect to the valve seat when the valve member is in the closed position. In certain examples, the sealing collar can be radially expandable and compressible to facilitate inserting the sealing collar through the valve seat and installing the sealing collar on the valve member. In one example, the sealing collar can include a collar body having a central hub on which the seal is mounted and resilient cantilever fingers that project from the central hub. In certain examples, the sealing collar can be secured to the valve member (e.g., to an enlarged head of the valve member) by a snap-fit connection.

In certain examples, valve designs in accordance with the principles of the present disclosure allow for two or more portions (e.g., a first port portion and a second port portion) of a valve housing to be formed as a singled unitary body while still allowing a valve member to be installed within the valve housing. Such a unitary construction of the valve housing assists in eliminating potential leak paths, in reducing part counts, in reducing cost and weight and in enhancing internal flow characteristics (e.g., pressure drop) of the valve.

Another aspect of the present disclosure relates to a coupling assembly comprising a main body forming a valve housing that extends along a housing axis. The valve housing includes a first port end defining a first port and a second port end defining a second port. The valve housing defines a flow passage that extends through the valve housing from the first port to the second port. The valve housing further defines an internal valve seat. A valve guide is positioned within the flow passage. A valve member is supported by the valve guide within the valve housing and the valve member being moveable along the housing axis relative to the internal valve seat and the valve guide. The valve member includes a valve head and a valve shaft. The valve shaft extends along the housing axis and being supported for movement along the housing axis by the valve guide. The valve member is moveable relative to the internal valve seat between an open position and a closed position. The valve member being spring biased toward the closed position. A collar is configured to mount to the valve head. The collar has a construction that is radially movable between a first radial configuration and a second radial configuration that is radially larger than the first radial configuration. The first radial configuration is configured to allow the collar to be inserted through the internal valve seat. The second radial configuration is configured to retain the collar on the valve head. A valve head assembly including the valve head and the collar. The collar is configured such that when the collar is mounted on the valve head. The collar moves with the valve member relative to the internal valve seat between the open position and the closed position and prevents the valve head from moving through the valve seat. When the valve member is in the closed position with the collar mounted on the valve head, the valve head assembly seals the internal valve seat preventing fluid flow through the internal valve seat. When the valve member is in the open position the valve head assembly with the collar mounted on the valve head fluid flow through the flow passage between the first port and the second port is allowed.

Another aspect of the disclosure pertains to a method of assembly of a coupling assembly, the coupling assembly including a valve seat adjacent a valve port. The method includes attaching a seal to one of a valve member or a collar, inserting the valve member through the valve port and the valve seat into an interior of the coupling assembly, inserting the collar through the valve port and the valve seat and installing the collar on the valve member within the interior of the coupling assembly, and wherein after installation of the collar on the valve member, the collar prevents the valve member from passing through the valve seat and provides valve sealing with respect to the valve seat when the valve member is in a closed position.

### BRIEF DESCRIPTION OF THE DRAWINGS

FIG. 1 is an exploded view of a coupling assembly in accordance with the principles of the present disclosure;

FIG. 2 is a perspective view of the coupling assembly of FIG. 1 assembled;

FIG. 3 is a cross-sectional view of the coupling assembly of FIG. 2.

FIG. 4 is a front (e.g., first port end) view of a main body of the coupling assembly of FIG. 1;

FIG. 5 is a back (e.g., second port end) view of the main body of FIG. 4;

FIG. 6 is a side view of the main body of FIG. 4;

FIG. 7 is a perspective view of a valve member of the coupling assembly of FIG. 1;

FIG. 8 is a side view of the valve member of FIG. 7;

FIG. 9 is a front view of the valve member of FIG. 7;

FIG. 10 is a back view of the valve member of FIG. 7;

FIG. 11 is a front prospective view of a collar of the coupling assembly of FIG. 1;

FIG. 12 is a back prospective view of the collar of FIG. 11;

FIG. 13 is front view of the collar of FIG. 11;

FIG. 14 is a back view of the collar if FIG. 11;

FIG. 15 is a side view of the collar of FIG. 11;

FIG. 16 is a cross-sectional view of the collar of FIG. 11 being inserted into the main body of the coupling assembly of FIG. 1;

FIG. 17 is a perspective view of the collar of FIG. 11 engaged with the valve member of FIG. 7;

FIG. 18 is a cross-sectional view of the coupling assembly of FIG. 1 in a closed position; and

FIG. 19 a cross-sectional view of the coupling assembly of FIG. 1 in an open position;

FIG. 20 illustrates a cross sectional view of an alternate embodiment of a coupling assembly in accordance with the present disclosure;

FIG. 21 illustrates a front perspective view of a valve member of the coupling assembly of FIG. 20;

FIG. 22 illustrates a side view of the valve member of FIG. 20;

FIG. 23 illustrates a back perspective view of the valve member of FIG. 20;

FIG. 24 illustrates a perspective view of a collar of the coupling assembly of FIG. 20;

FIG. 25 illustrates a perspective view of a valve guide of the coupling assembly of FIG. 20;

FIG. 26 illustrates a perspective view of an alternative valve guide of the coupling assembly of FIG. 20;

FIG. 27 illustrates a cross sectional view of coupling assembly of FIG. 20 with the collar of FIG. 24 joining to the valve member of FIG. 21.

### DETAILED DESCRIPTION

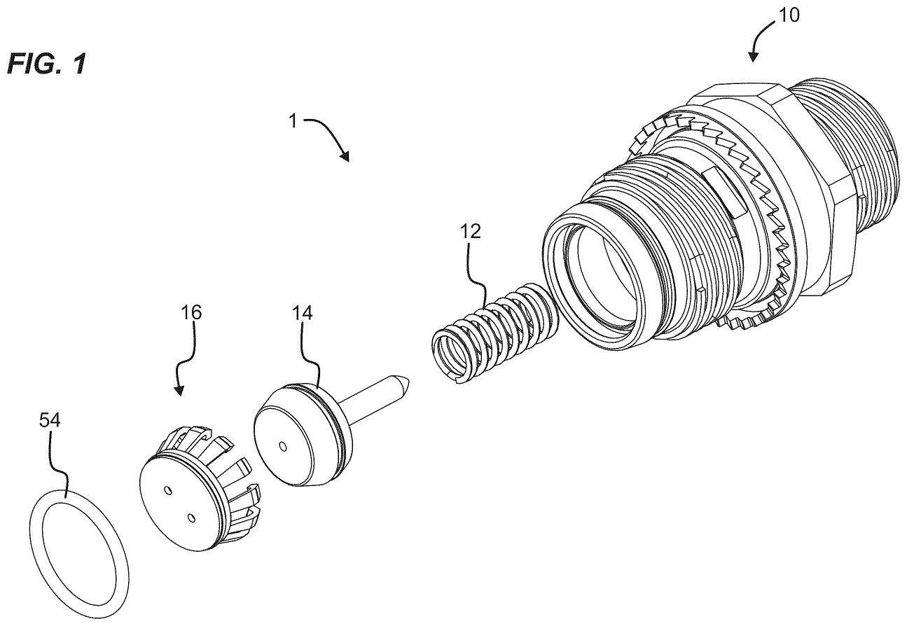

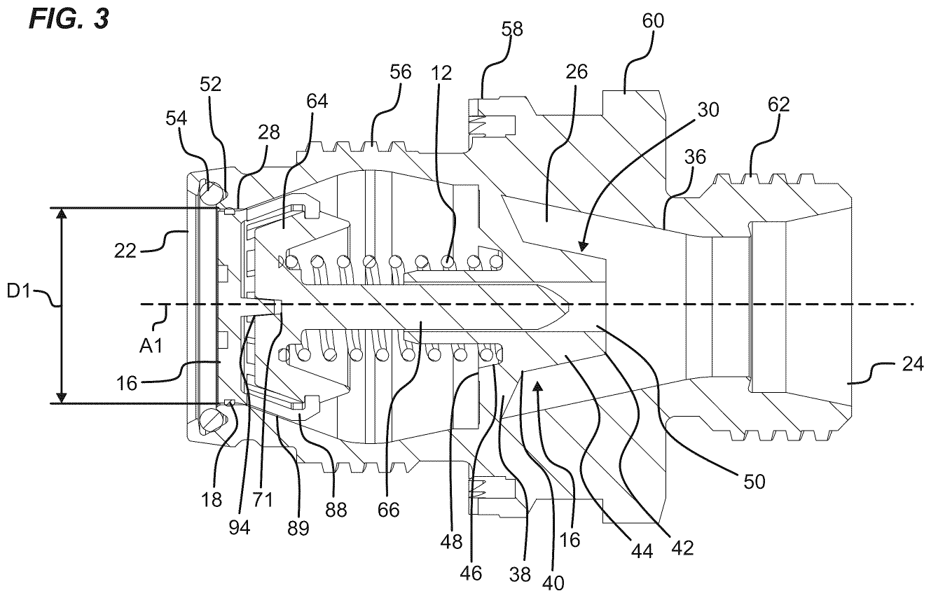

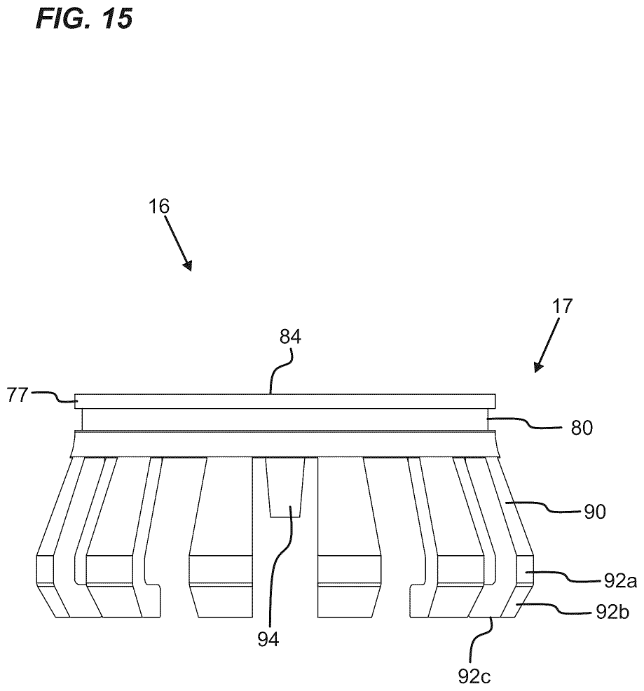

FIG. 1 shows an exploded view of a coupling assembly 1 (e.g., a quick disconnect coupling assembly) in accordance with the principles of the present disclosure. The coupling assembly 1 includes a main body 10, a valve spring 12, a valve member 14, and a collar 16 including a collar body 17 (shown in FIG. 15) and a collar seal 18 (shown in FIG. 3). The main body 10 forms a valve housing 20 which allows for the valve spring 12, the valve member 14, and the collar 16 to be inserted through a first port 22 and an internal valve seat 28 into an interior the main body 10. The valve member 14 and the collar 16 are movable to seal against the internal valve seat 28. The valve spring 12 is configured to bias the valve member 14 toward a closed position. In some instances, the collar seal 18 may be bonded to the collar body 17 before the collar 16 is inserted into the main body 10. The collar 16 may be configured to radially expand and contract to facilitate attaching the collar 16 to the valve member 14 and to facilitate inserting the collar 16 through the valve seat 28. The collar 16 may be movable with (e.g., carried with) the valve member 14 as the valve member 14 moves between open and closed positions. When the valve member 14 is in the closed position, the seal 18 can seal against a sealing surface of the valve seat 28 that defines an inner diameter D1 of the internal valve seat 28. The sealing surface can face radially toward a valve axis of the coupling assembly 1 and the seal 18 can be a radial seal that is compressed radially during sealing. The seal 18 prevents fluid flow past the collar 16 and valve member 14 when the valve member 14 is in the closed position and the collar 16 is positioned within the diameter D1 of the internal valve seat 28.

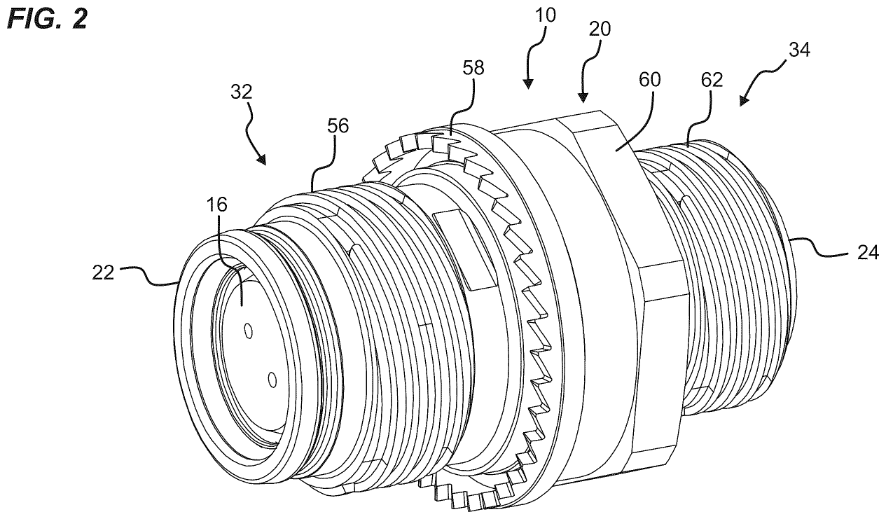

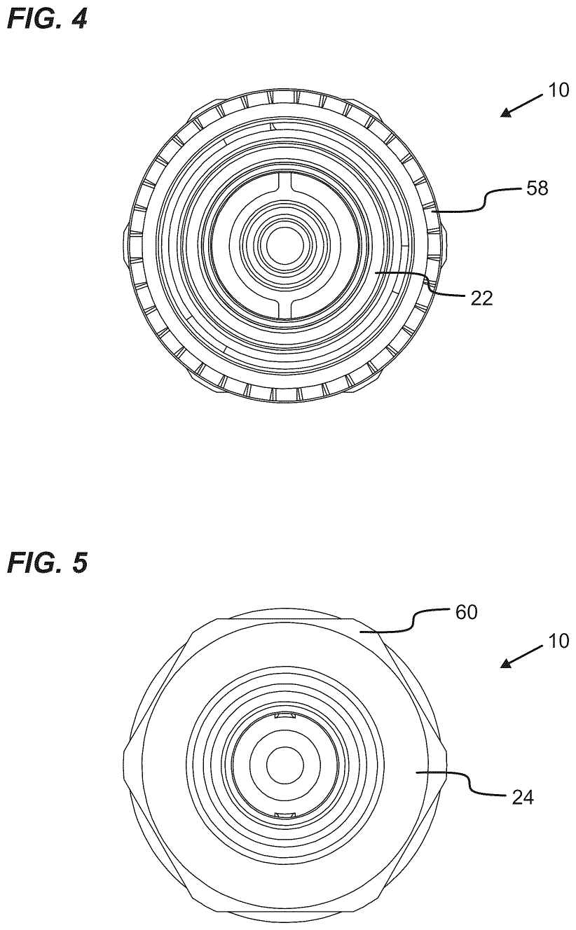

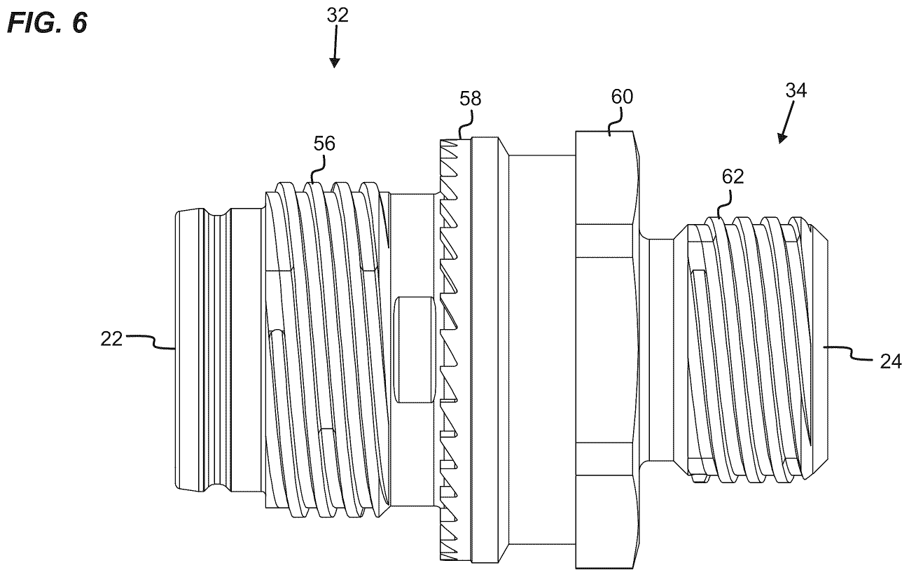

FIGS. 2-6 illustrate as depicted the main body 10 which forms the valve housing 20 for the quick disconnect coupling assembly 1. FIG. 3 illustrates the valve housing 20 of main body 10 may define the first port 22, a second port 24, an inner flow passage 26 between the first port 22 and the second port 24, and the internal valve seat 28. The main body 10 may have a first housing end 32 (shown in FIG. 2) and a second housing end 34 (shown in FIG. 2). The first port 22 is positioned at the first housing end 32 and the second port 24 at the second housing end 34. The first port 22 may include a first port groove 52 to allow the positioning of a first port seal 54. The first port seal 54 may be an elastomeric seal. The inner flow passage 26 is further defined by an interior circumferential surface 36 of the main body 10 and extends along a housing axis A1. The valve housing 20 narrows near the first port 22 of the valve housing 20 to form the internal valve seat 28. As shown in FIG. 2, the main body 10 may have a first threaded portion 56 on an exterior of the first housing end 32 for allowing another fluid conduit to be connected to the quick disconnect coupling assembly 1 via a coupler. The quick disconnect coupling assembly 1 may be a male quick disconnect coupling assembly 1. In other instances, the coupling assembly 1 may be a female quick disconnect coupling assembly. An exterior of the second port 24 may include a second threaded portion 62 for securing a connection to another structure (e.g., threaded into a threaded port or coupled to another structure with a coupler).

The main body 10 may include other aspects as desired. As non-limiting examples, the main body 10 may further comprise a ratchet ring 58 for further securing a connection made with a coupler. The ratchet ring 58 may include teeth for engaging the end of a coupling sleeve threaded on the first threads 56. Additionally, the main body 10 may further include a polygonal surface 60, such as wrench flats, for gripping and turning the main body 10 to apply torque or to allow torque to be applied.

FIG. 3 further shows a valve guide 30 may be positioned within the main body 10. In some instances, the valve guide may be positioned within the inner flow passage 26 by one or more arms 38. Arms 38 extend from the interior circumference of the main body 10 to position the valve guide 30 along the housing axis A1. The valve guide 30 can be any shape desired to achieve desired pressure drop within the flow passage 26. In some instances, the valve guide 30 may be tapered in shape with a major end 40 and a minor end 42. The minor end 42 is positioned within the inner flow passage 26 downstream of the major end 40. The valve guide 30 includes a core 44 aligned on the housing axis A1 for receiving the valve member 14, and a spring groove 46 is positioned on a first port facing surface 48 of the valve guide 30. The spring groove 46 encircles an opening 50 of the core 44 on the first port facing surface 48 of the valve guide 30.

In some embodiments, the main body 10 may be a seamless molded unitary piece. In a preferred embodiment, the main body 10 may be made in accordance with an additive manufacturing process. As a benefit of using additive manufacturing processes, complex shapes of the exterior and interior of the main body may be formed as a unitary piece. As a unitary piece, the main body 10 may define the first port 22, the second port 24, the inner flow passage 26, the first and second threaded portions 56, 62, the ratchet ring 58, the polygonal surface 60, and the valve guide 30. The arms 38 of the valve guide 30 may be unitarily formed (e.g., molded or additive manufacturing) as part of the main body 10 to position the valve guide 30 along the housing axis A1. Advantageously, the number of parts may be reduced during assembly. Further, by utilizing a molded unitary main body 10, the possibility of leakage paths out of the valve housing 20 is reduced.

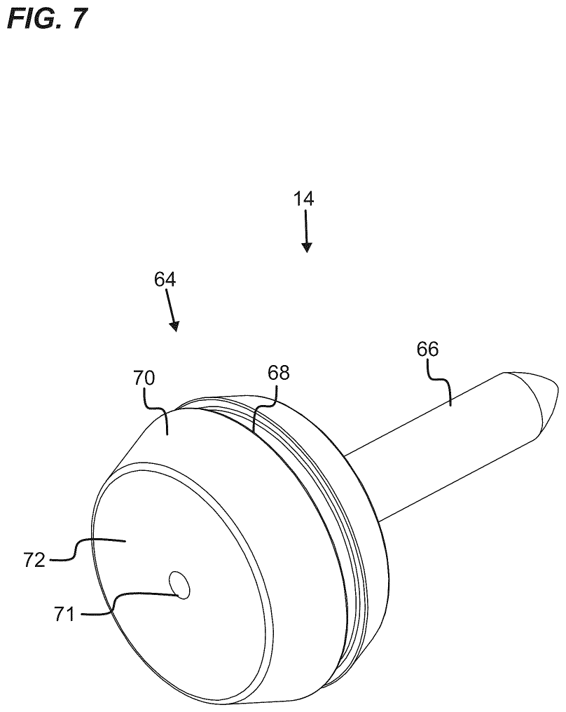

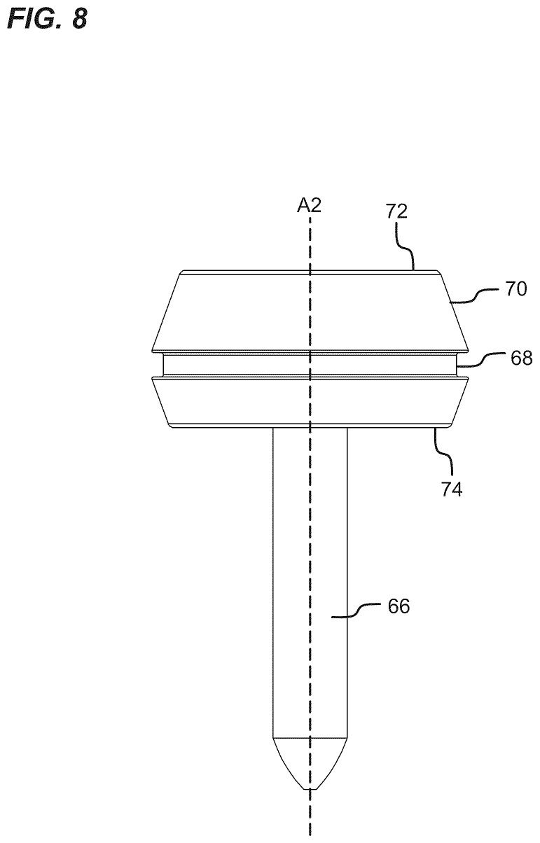

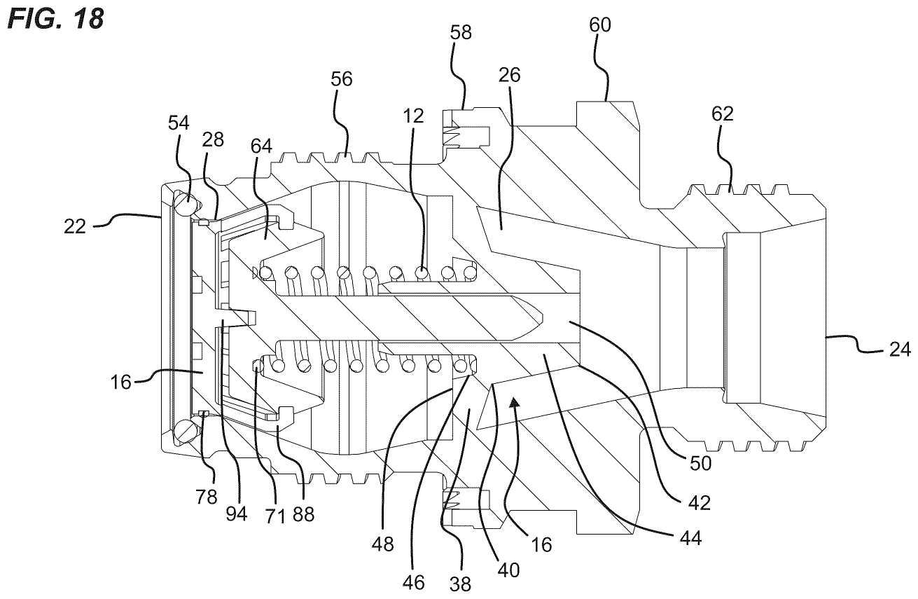

FIGS. 7-10 show the embodiments of the valve member 14 which may be inserted into the main body 10. The valve spring 12 may be positioned within the spring groove 46. The valve member 14 is inserted through the internal valve seat 28 and the valve spring 12, into the core 44 of the valve guide 30. The valve member 14 includes a valve head 64 and a valve shaft 66 that extends along the housing axis A1. The valve shaft 66 has a valve axis A2 that aligns with the housing axis A1 when inserted into the core 44. The valve head 64 is smaller than a diameter D1 of the internal valve seat 28. The valve shaft 66 extends along the housing axis A1 and is supported for movement along the housing axis A1 by the valve guide 30. The valve member 14 is moveable relative to the internal valve seat 28 (shown in FIG. 3) between an open position and a closed position. The valve member 14 is spring biased toward the closed position (shown in FIGS. 3 and 18). The valve head 64 defines an outer circumferential groove 68. The valve head 64 also comprises pin openings 71 on an axial end face 72 of the valve head 64, which faces the first port 22 of the valve housing 20. In some instances, the circumference of the valve head 64 may be a tapered surface, such that the collar 16 may expand around the tapered surface when the collar 16 is pressed against the valve head 64. The valve spring 12 biases the valve member 14 towards the internal valve seat 28 by pushing against the spring groove 46 of valve guide 30 (e.g., at a spring stop surface provided at the spring groove 46) and a back surface 74 of the valve head 64.

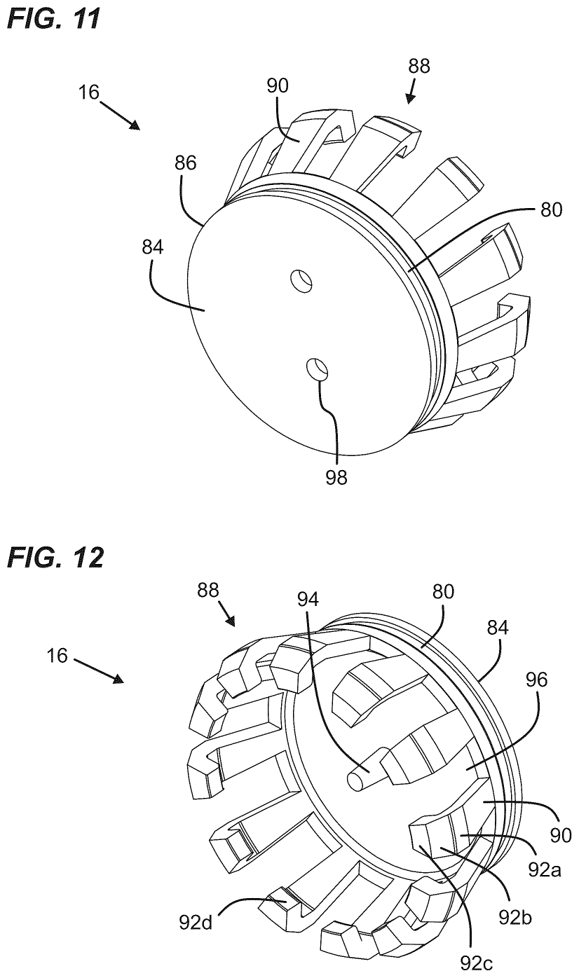

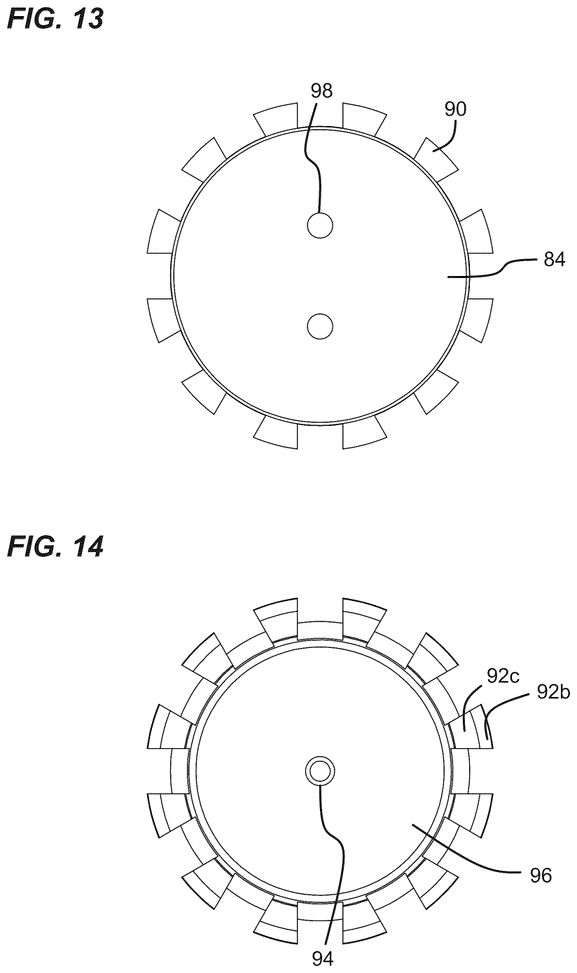

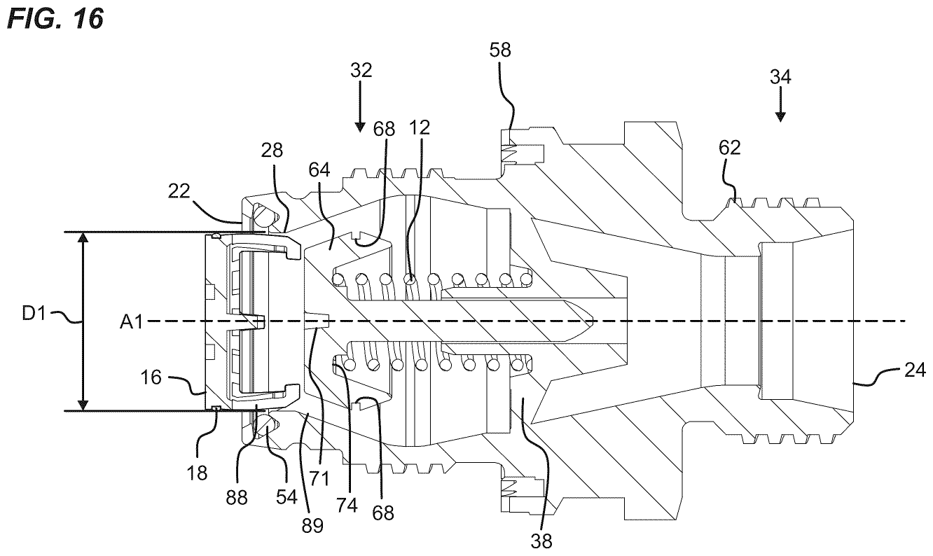

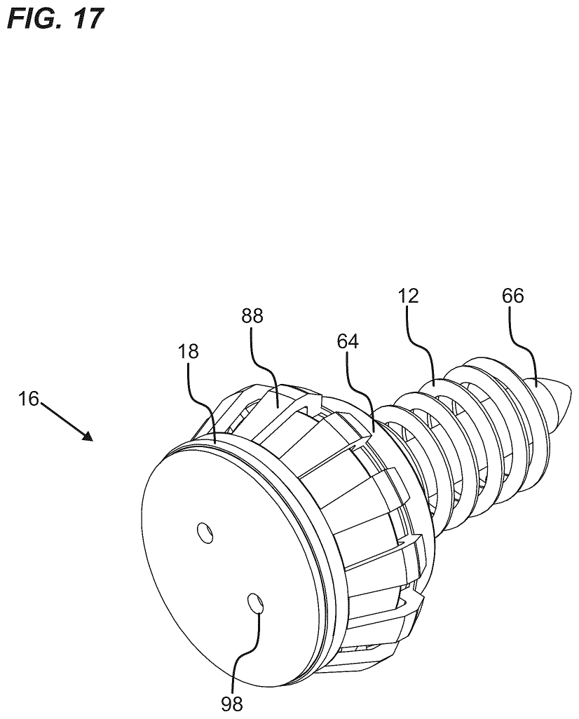

FIGS. 11-15 show the features of the collar 16 which join to the valve member 14. FIG. 11 shows the collar 16 including a collar body 17 (shown in FIG. 15) configured to mount to the valve head 64. The collar body 17 may further include the collar seal 18 (shown in FIGS. 16 and 17) carried by the collar body 17 for providing sealing between the collar body 17 and the valve seat 28 when the collar 16 is mounted to the valve head 64 and the valve member is in the closed position (shown in FIG. 16). The collar body 17 may include a central hub 77 (shown in FIG. 15) on which the collar seal 18 mounts. The central hub 77 defines a seal groove 80 that extends circumferentially about the central hub 77. The collar seal 18 mounts within the seal groove 80, and the seal 18 is adapted to provide radial scaling with respect to the valve seat. The collar body 17 includes a front surface 84 and a circumferential surface 86 positioned at a 90-degree angle relative to the front surface 84. The central hub 77 may further include a plurality of circumferential spaced apart resilient cantilever fingers 88 having finger lengths that extend from base ends formed with the central hub 77 to free ends. The resilient cantilever fingers 88 include radial retention tabs 92 at the free ends of the resilient cantilever fingers 88, and an angled portion 90 relative to the collar body 17. The angled portion 90 is positioned between and joining the retention tabs 92 to collar body 17. The radial retention tabs 92 fit within the outer circumferential groove 68 to retain the collar 16 on the valve head 64. The tabs 92 may include a first region 92a, a second region 92b and a third region 92c. The first region 92a is parallel to the circumferential surface 86 of the collar body 17. The second region 92b is angled between the first and third region 92b. The third region 92c is a tab at the free end, which projects radially inward towards the center of the collar 16. The third region 92c includes a radially inward facing surface 92d which may engage the outer circumferential groove 68. Between each resilient cantilever finger 88 are spaces extending to the collar body 17. The spaces between the resilient cantilever fingers 88 do not extend to the seal groove 80 to prevent leakage paths from forming when compressed. FIG. 12 show features of the collar 16 which engage the axial end face 72 of the valve head 64.

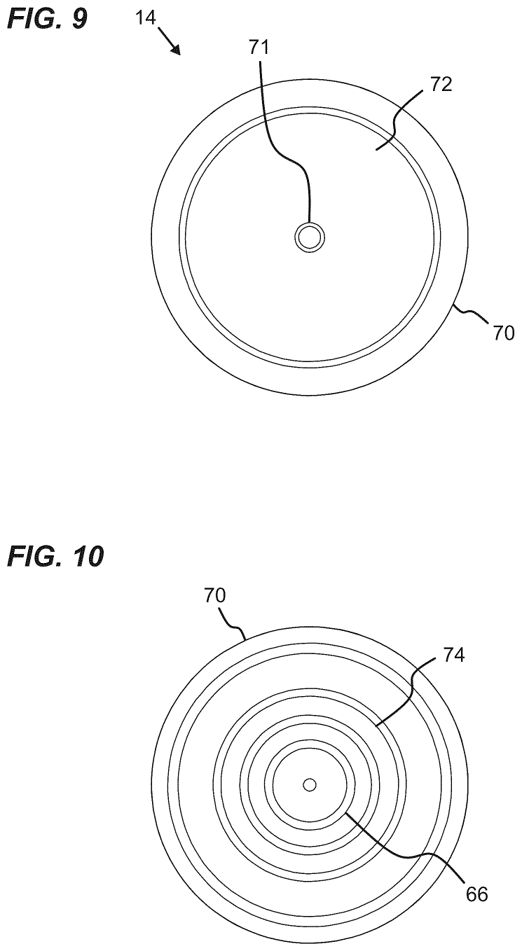

In some embodiments, the collar 16 may include additional features to prevent movement of the collar 16 once joined to the valve head 64. In some embodiments, at least one axial pin 94 may be positioned a back surface 96 of the central hub 77 for engaging the collar 16 with the valve head 64. The at least one pin 94 may be a truncated conical pin which nests within the pin opening 71 (shown in FIG. 9) on the axial end face 72 of the valve head 64. The pin opening 71 may be configured to be the same shape as the at least one pin 94. In other embodiments, the number of pins 94 may be at least two to prevent axial rotation of the collar 16. Some embodiments may allow the pin 94 to have different shapes. As non-limiting examples, the pin 94 may be chamfered to prevent radial movement of the collar 16 relative to the housing axis A1. As another non-limiting example, the pin 94 may be cylindrical. In other instances, the pin 94 may be polygonal, such as square, to prevent axial rotation of the collar 16 around the valve head 64.

FIG. 15 shows the circumferential surface 86 of the collar body 17. The seal groove 80 is positioned around the circumferential surface 86. The collar seal 18 fits within the seal groove 80 (Shown in FIGS. 17 and 18) and seals fluid flow between the internal valve seat 28 and the collar 16 when closed (Shown in FIG. 18). The collar seal 18 may be made of ethylene propylene rubber or neoprene. Additionally, the collar seal 18 is molded directly to the collar 16 on the seal groove 80 before the collar 16 is inserted into the valve housing 20. The valve seat is sealed because the diameter of the seal in a non-compressed state is greater than the internal valve seat 28 but allows for the seal to be elastically deformed (e.g., radially compressed) to fit between the collar body 17 and the radially inwardly facing sealing surface of the internal valve seat 28 when in a closed position.

In other embodiments, the seal 18 may be bonded to the valve housing 20 rather than the collar 16. For instance, the seal 18 may be bonded within a groove positioned within the internal valve seat 28. The collar 16 may seal with the valve seat 28 when collar 16 is mounted to the valve head 64 and the valve member 14 is in the closed position. As an example, the collar 16 may have a non-grooved sealing surface. When the collar member is mounted to the valve member 14 and the valve member 14 is moved to a closed position, the collar 16 may move with the valve member 14 and the non-grooved sealing surface seals against the seal 18 positioned within the internal valve seat 28. When the valve member 14 is in the open position with the collar 16 mounted on the valve head 64, fluid flow is allowed through the flow passage 26 between the first port 22 and the second port 24.

FIGS. 16 and 17 show the attachment of the collar 16 to the valve head 64 within the main body 10. As shown in FIGS. 16 and 17, the plurality of circumferentially spaced-apart resilient cantilever fingers 88 may be contracted and expanded from a resting position to engage the valve head 64. The collar 16 may be made from a metal which allows the resilient cantilever fingers 88 to be spring biased towards a resting position. Because of the spring bias, the collar 16 may be placed in numerous configurations by manipulating the plurality of circumferentially spaced-apart resilient cantilever fingers 88. When the fingers 88 are contracted, the resilient cantilever fingers 88 may spring bias to expand back to the resting position. When fingers 88 are expanded, the resilient cantilever fingers 88 may spring bias back to the resting position.

As non-limiting examples of possible configurations, the collar 16 may be positioned in a first radial configuration to fit through the internal valve seat 28, a resting radial configuration, a maximally expanded radial configuration, and a second radial configuration in which the tab 92 is engaged with the outer circumferential groove 68. The resting configuration and the maximally expanded radial configuration may be intermediate states during the transition from the first radial configuration to the second radial configuration. For instance, in the first radial configuration, the resilient cantilever fingers 88 may be compressed radially inward to allow the collar 16 to be inserted through the internal valve seat 28. In the second radial configuration, the resilient cantilever fingers 88 are at the resting position with no manipulation. A diameter of resilient cantilever fingers 88 during the resting radial configuration are larger than the diameter of the internal valve seat 28 and prevent the collar 16 from being moved through the internal valve seat 28. The resilient cantilever fingers 88 being configured to resiliently flex along their lengths relative to the central hub 77 to move the collar body 17 between the first radial configuration and the resting radial configuration. In the maximally expanded radial configuration, the resilient cantilever fingers 88 are configured to flex radially outwardly beyond the resting radial configuration to a maximally expanded configuration during insertion of the collar body over the valve head. The resilient cantilever fingers 88 may be maximally expanded as the finger 88 is pressed against the tapered surface of the valve head 64 and allow the valve head 64 to positioned between the resilient cantilever fingers 88. In the second radial configuration, the resilient cantilever fingers 88 are configured to resiliently move from the maximum expanded configuration to the resting radial configuration as the radial retention tabs 92 fit into the outer circumferential groove 68. The resilient cantilever fingers 88 may snap-fit into the outer circumferential groove 68. During the second radial configuration, the resilient cantilever fingers 88 are expanded greater than the resting radial configuration but are expanded less than the maximally expanded radial configuration.

When the cantilever fingers 88 are in the second radial configuration corresponding to the collar 16 being mounted on the valve head 64 of the valve member 14, the fingers 88 are arranged in an outwardly taped configurations in which the fingers 88 flare or taper radially outwardly as the fingers 88 extend axially inwardly from the central hub 77 of the collar 16 into the valve. When the collar 16 is installed on the valve head 64, the taped outer structure defined by the fingers 88 functions as a valve stop that opposes/contact a tapered stop surface 89 (shown best in FIG. 16) defined within the valve housing around the valve seat 28 to stop outward axial movement of the valve member 14 when the seal 18 is within the region defined by the radially inwardly facing surface of the valve seat 28. In one example, the tapered outer structure defined by the angled portion 90 of the fingers 88 can nest within the tapered stop surface of the valve seat.”

FIG. 16 shows the collar 16 may be manipulated into the first configuration to fit through the internal valve seat 28 to begin joining the collar 16 to the valve head 64. Once through the internal valve seat 28, the resilient cantilever fingers 88 of the collar 16 may be expanded and return to the resting configuration. From the resting configuration, the collar 16 may be pushed against the valve head 64 and allow the resilient cantilever fingers 88 to expand to the maximally expanded radial configuration around the valve head 64. As shown in FIG. 17, once the resilient cantilever fingers 88 are pushed to the outer circumferential groove 68, the resilient cantilever fingers 88 are spring biased to the second radial configuration to engage the outer circumferential groove 68. The angled portion 90 will expand radially around the circumference 70 (shown in FIG. 7) of the valve head 64 and the radially inward facing surface 92d of the third region 92c will engage the outer circumferential groove 68. The at least one pin 94 may be inserted into the pin openings 71 on the axial end face 72 of the valve head 64 as the resilient cantilever fingers 88 are pushed to engage the outer circumferential groove 68. In some instances, the collar body 17 of the collar 16 may further include at least one hole 98 on a front surface 84 of the collar body 17. The at least one hole 98 allows a tool to hold and push the collar 16 after the resilient cantilever fingers 88 have been inserted through the internal valve seat 28. The resilient cantilever fingers 88 when engaged against the outer circumferential groove 68 self-align the collar 16 with the valve member 14 along the housing axis A1.

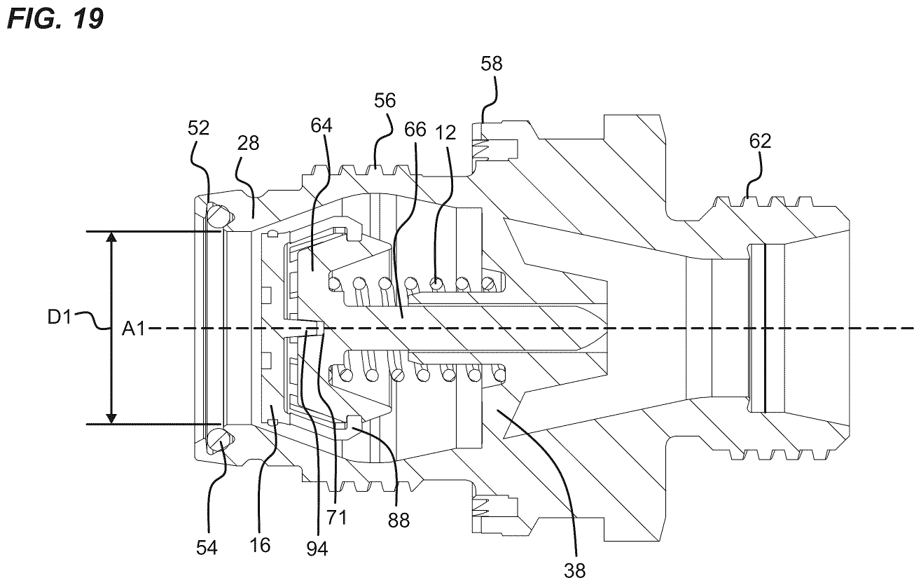

FIG. 18-19 illustrate the opening and closing of the quick disconnect coupling assembly 1. The collar 16 moves with the valve member 14 relative to the internal valve seat 28 between the open position and closed position. FIG. 15 illustrates the closed position of the quick disconnect coupling assembly 1. When closed, the collar 16 is biased toward the internal valve seat 28. The collar body 17 is positioned within the diameter D1 of the internal valve seat 28 and the collar seal 18 forms a sealing surface which contacts the internal valve seat 28 preventing fluid flow through the internal valve seat 28. The valve spring 12 biases against a back surface 74 of the valve head 64 and holds the valve head 64 against the internal valve seat 28 in the closed position. As shown in FIG. 16, during an open position the valve head 64 is displaced from the internal valve seat 28, which moves the collar body 17 and collar seal 18 out of the internal valve seat 28 allowing fluid flow through the first port 22, the inner flow passage 26, and exiting the second port 24.

The method of making and assembling a valve comprising initially molding a unitary main body 10 which forms a valve housing 20. The valve housing may define a port, such as first port 22 or second port 24, and the valve seat 28. A valve guide 30 may be positioned within the main body 10. The valve spring 12 may be inserted through the first port 22 and into the spring groove 46. The valve member 14 may then be inserted through the valve spring 12 and into the valve guide 30. The collar 16 may joined to the valve head 64 of the valve member 14. The collar 16 may be inserted through the first port 22 into the valve housing 20 by compressing resilient cantilever fingers 88 such that the fingers 88 may fit through the first port 22. Once compressed the resilient cantilever fingers 88 may be inserted through the first port 22 and valve seat 28. Once inserted through the valve seat 28, the resilient cantilever fingers 88 may stop being radially compressed, and the resilient cantilever fingers 88 may expand back to a resting position. A tool may be used to press the collar 16 against the valve head 64. The force against the collar 16 may cause resilient cantilever fingers 88 to press against the tapered surface of the valve head 64 and radially expand around the valve head 64. After the collar is sufficiently pressed against the tapered surface of the valve head 64, resilient cantilever finger 88 may begin to expand over the tapered surface. Next, the resilient cantilever fingers 88 may be pushed to maximally expand around the valve head 64 and then move to the outer circumferential groove 68. Once the fingers 88 reach the outer circumferential groove 68, the resilient cantilever fingers 88 engage the outer circumferential groove 68 of the valve head 64. As an example, the tab 92 may be snap-fit into the groove 68 such that the radially inward facing surface 92d is inserted into the outer circumferential groove 68 to join the collar 16 to the valve head. After installation of the collar 16 on the valve member 14, the collar 16 prevents the valve member 14 from passing through the valve seat 28 and the seal 18 provides valve sealing with respect to the valve seat 28 when the valve member 14 is in a closed position.

In some instances, the unitary main body 10 may include forming the valve guide 30 as part of the main body 10. In other instances, the valve guide 30 may be a separate component inserted into the valve housing 20. As a non-limiting example, the valve guide 30 may be positioned by being inserted through the first port 22 and press-fit within the valve housing 20. In some instances, the collar seal 18 may be molded directly to the collar body 17 of collar 16. In some instances, the seal is molded directly into the seal groove 80.

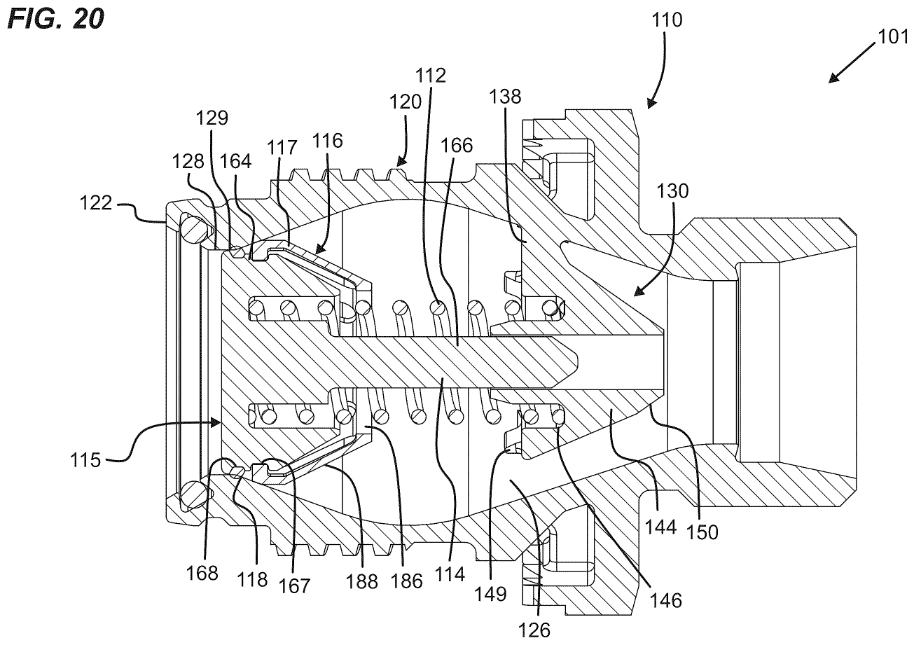

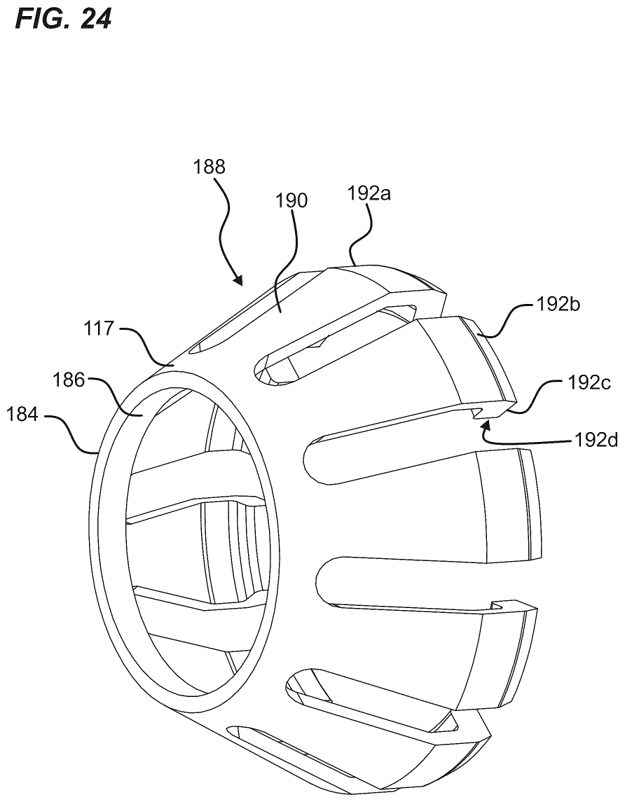

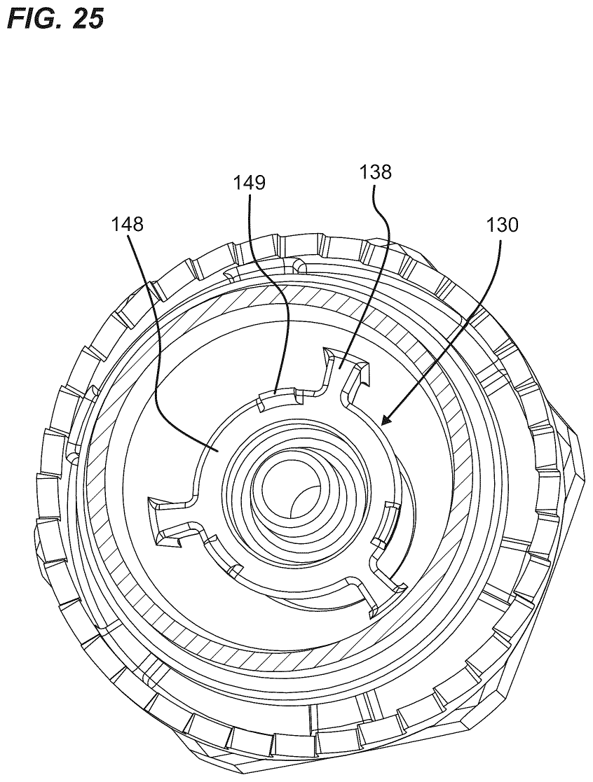

FIG. 20 illustrates an alternate embodiment of a coupling assembly 101 in accordance with the present disclosure. The coupling assembly 101 includes a main body 110, a valve spring 112, a valve member 114, and a collar 116 including a collar body 117 (shown in FIG. 24) and a seal 118. The main body 110 forms a valve housing 120 which allows for the valve spring 112, the valve member 114, and the collar 116 to be inserted through a first port 122 and an internal valve seat 128 into an interior of the main body 110. The valve member 114 and the collar 116 are movable to seal against the internal valve seat 128. The valve spring 112 is configured to bias the valve member 114 toward a closed position. A valve head assembly 115 may be used to seal against the internal valve seat 128. The valve head assembly 115 includes the valve member 114 and the collar 116. The collar 116 may be configured to radially expand and contract to facilitate attaching the collar 116 to the valve member 114 and to facilitate inserting the collar 116 through the valve seat 128. The collar 116 may be movable with (e.g., carried with) the valve member 114 as the valve member 114 moves between open and closed positions. The valve member 114 may include the seal 118. When the valve member 114 is in the closed position, the seal 118 can seal against a sealing surface 129 of the valve seat 128 that defines an inner diameter D1 of the internal valve seat 128. The sealing surface 129 can generally face radially toward a valve axis of the coupling assembly 101; however, a portion of the sealing surface may be angled relative to the valve axis. The seal 118 can be a radial seal that is compressed radially during scaling. For instance, the seal 118 is radially compressed to be fit through the sealing surface 129 of the valve seat 128 and expands to form a radial seal. The sealing surface 129 may be annular and cylindrical. The seal 118 prevents fluid flow past valve member 114 when the valve member 114 is in the closed position and the valve member 114 is positioned within the diameter D1 of the internal valve seat 128. The seal 118 radially seals with the sealing surface 129 of the valve seat.

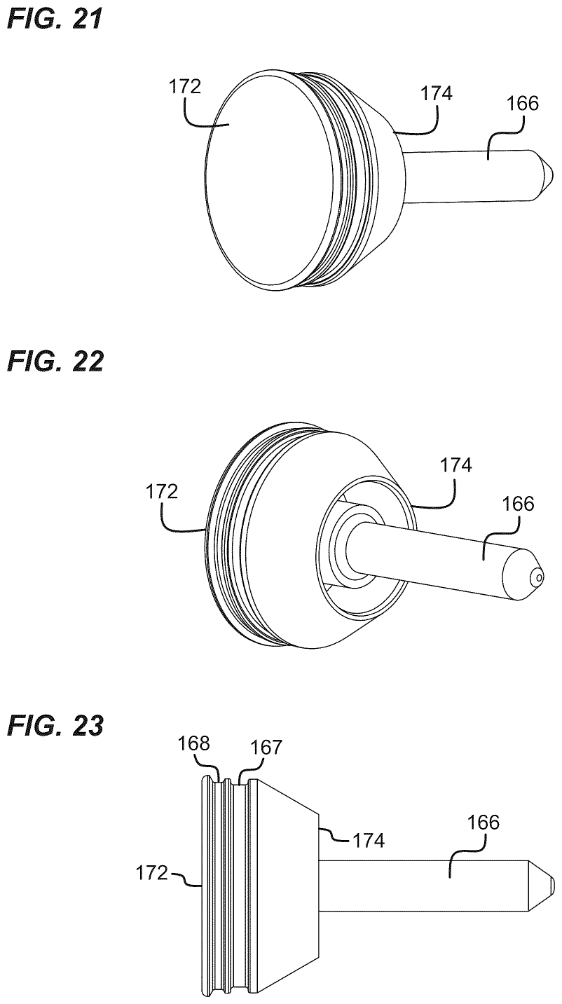

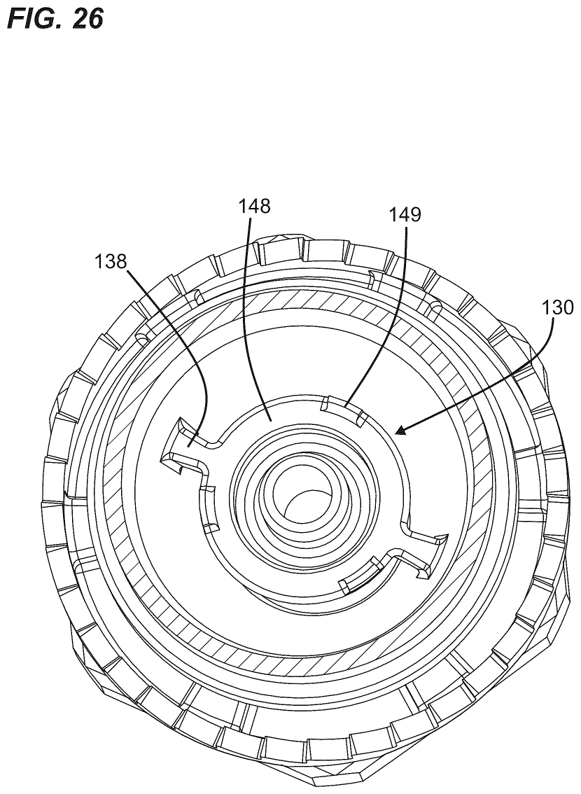

FIG. 21-26 illustrates the valve head assembly 115. FIG. 21-23 illustrates a perspective views of the valve member 114. The valve head 164 of valve member 114 includes a front axial end face 172 and a back surface 174. The back surface 174 tapers to the front axial end face. The back surface 174 may be a minor end and the front axial end face 172 may be a major end. The valve head 164 may include a first outer circumferential groove 167 around the circumference of the valve head 164 and a second outer circumferential groove 168. The first outer circumferential groove 167 can allow the collar 116 to be retained within the first outer circumferential groove 167 and the collar 116 may be movable with the valve member 114 between the open and closed positions. A lip may separate the first and second grooves. The second outer circumferential groove 168 may receive the seal 118. The valve head 164 may be moved to press the seal 118 against the internal valve seat 128 and seal fluid flow through the passage 126.

FIG. 24 illustrates a perspective view of the collar 116. The collar 116 of the valve head assembly 115 may be positioned between the valve guide 130 and a back surface 174 of the valve member 114. The collar 116 includes a front surface 184, and a plurality of cantilever fingers 188. The front surface 184 may include an opening 186 to receive the valve member 114. For instance, the valve shaft 166 and the back surface 174 of the valve head 164 may be received through the opening 186. The cantilever fingers 188 may be moved between a resting configuration, a first radial configuration, a second radial configuration, and a maximally expanded configuration. A side of the collar body 117 having the opening 186 may rest against a tapered surface of the valve head 164 or against the back surface 174 of the valve head. The resilient cantilever fingers 188 include radial retention tabs 192 at the free ends of the resilient cantilever fingers 188, and an angled portion 190 relative to the collar body 117. The angled portion 190 is positioned between and joining the retention tabs 192 to collar body 117. The radial retention tabs 192 fit within the first outer circumferential groove 167 to retain the collar 116 on the valve head 164. The tabs 192 may include a first region 192a, a second region 192b and a third region 192c. The first region 192a is parallel to the circumferential surface of the collar body 117. The second region 192b is angled between the first and third region 192a, 192c. The third region 192c is a tab at the free end, which projects radially inward towards the center of the collar 116. The third region 192c includes a radially inward facing surface 192d which may engage the first outer circumferential groove 167. Between each resilient cantilever finger 188 are spaces extending to the collar body 117.

FIGS. 21, 25, and 26 illustrates the valve guide 130 of the present disclosure receiving the valve head assembly 115. The valve guide 130 includes a core 144 aligned on the housing axis A1 for receiving the valve member 114, and a spring groove 146 is positioned on a first port facing surface 148 of the valve guide 130. The spring groove 146 encircles an opening 150 of the core 144 on the first port facing surface 148 of the valve guide 130. The valve guide 130 may be unitary with the main body 110. The valve guide 130 may include at least one arm 138 which are integrally formed with the main body 110. In some instances, the valve guide 130 may include two arms 138. In the present example, the valve guide 130 includes three equidistantly spaced arms 138 within the passage. As such, the arms 138 are space 120 degrees apart from each other to position with valve guide 130 centrally within the internal passage 126. The valve guide 130 may include protrusions 149 spaced around a perimeter of a first port facing surface 148 of the valve guide 130. Beneficially, the arms 138 may assist in positioning the valve guide 130 concentrically in the center of the passage 128. Additionally, the arms 138 within the passage 126 provide improved stability of the valve guide 130 and a reduced pressure drop within the passage.

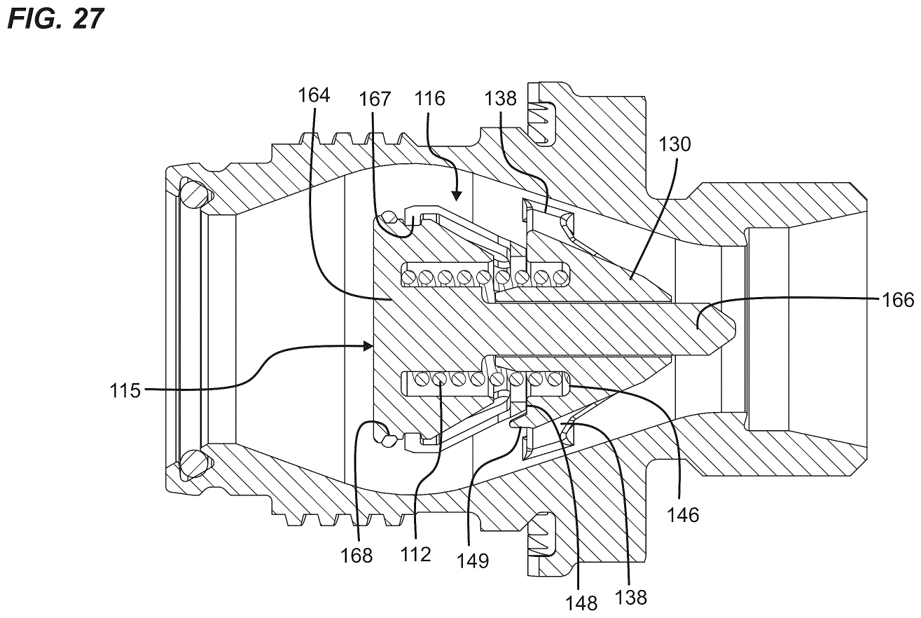

FIG. 27 illustrates the insertion of the valve head assembly 115. The collar 116 may be inserted through the first port 122 with the front surface 184 of the collar resting on the valve guide 130. The protrusions 149 may serve to position the collar 116 for joining to the valve member 114. The valve shaft 166 and the back surface 174 of the valve head 164 may then be inserted through the first port 122 and pressed between the resilient cantilever fingers 188 of the collar 116. The resilient cantilever fingers 188 may expand around the taper surface of the valve member 114 to engage the first outer circumferential groove 167 on the valve head 164. The fingers 188 may be retained within the first outer circumferential groove 167 and join the collar 116 to the valve head 164. As such, the collar 116 is retained on the valve head 164 and allows the collar 116 to move with the valve member 114 between the opened and closed positions. Advantageously, the system may have reduced leak paths, reduced parts in comparison to conventional disconnect assemblies, reduced weight. Further, the valve head assembly of the present embodiment would not require a tool to insert the collar 116 into the valve housing 120 and would have fewer steps to assemble.

Referring back to FIG. 20, the valve head assembly 115 is shown in the closed position. The valve member 114 may include a valve head 164. The second outer circumferential groove 168 of the valve head 164 retains the seal 118. When in the closed position, the seal 118 rests against the internal valve seat 128. The seal 118 may be a bonded seal. The collar 116 of the valve head assembly 115 may prevent the valve head 164 of the valve member 114 from moving through the valve seat 128.

The various examples described above are provided by way of illustration only and should not be construed to limit the scope of the present disclosure. Those skilled in the art will readily recognize various modifications and changes that may be made without following the example examples and applications illustrated and described herein, and without departing from the true spirit and scope of the present disclosure.

### ASPECTS OF THE PRESENT DISCLOSURE

Aspect 1. A coupling assembly comprising:
a main body forming a valve housing that extends along a housing axis, the valve housing including a first port end defining a first port and a second port end defining a second port, the valve housing defining a flow passage that extends through the valve housing from the first port to the second port, the valve housing further defining an internal valve seat;
a valve guide positioned within the flow passage;
a valve member supported by the valve guide within the valve housing, the valve member being moveable along the housing axis relative to the internal valve seat and the valve guide, the valve member including a valve head and a valve shaft, the valve shaft extending along the housing axis and being supported for movement along the housing axis by the valve guide; the valve member being moveable relative to the internal valve seat between an open position and a closed position, the valve member being spring biased toward the closed position;
a collar configured to mount to the valve head, the collar providing sealing with the valve seat when the collar is mounted to the valve head and the valve member is in the closed position, the collar having a construction that is radially movable between a first radial configuration and a second radial configuration that is radially larger than the first radial configuration, the first radial configuration being configured to allow the collar to be inserted through the internal valve seat, the second radial configuration being configured to retain the collar on the valve head, the collar being configured such that when the collar is mounted on the valve head the collar moves with the valve member relative to the internal valve seat between the open position and the closed position and prevents the valve head from moving through the valve seat, wherein when the valve member is in the closed position with the collar mounted on the valve head the collar seals the internal valve seat preventing fluid flow through the internal valve seat, and wherein when the valve member is in the open position with the collar mounted on the valve head fluid flow through the flow passage between the first port and the second port is allowed.

Aspect 2. The coupling assembly of aspect 1, wherein the main body defining the valve housing has a unitary seamless construction defining the first port, the second port, the valve seat and the flow passage.

Aspect 3. The coupling assembly of aspect 2, wherein the valve guide is unitary with the main body.

Aspect 4. The coupling assembly of aspect 1, wherein the collar includes a collar body including a central hub and a plurality of circumferentially spaced-apart resilient cantilever fingers that project from the central hub, the resilient cantilever fingers having finger lengths that extend from base ends formed with the central hub to free ends, the resilient cantilever fingers being configured to resiliently flex along their lengths relative to the central hub to move the collar body between the first radial configuration and the second radial configuration.

Aspect 5. The coupling assembly of aspect 4, wherein the valve head defines an outer circumferential groove, wherein the resilient cantilever fingers include radial retention tabs at the free ends of the resilient cantilever fingers, and wherein the radial retention tabs fit within the outer circumferential groove to retain the collar on the valve head.

Aspect 6. The coupling assembly of aspect 5, wherein the collar includes a seal that mounts to the central hub and is carried with the collar body.

Aspect 7. The coupling assembly of aspect 6, wherein the central hub defines a seal groove that extends circumferentially about the central hub, wherein the seal mounts within the seal groove, and wherein the seal is adapted to provide radial sealing with respect to the valve seat.

Aspect 8. The coupling assembly of aspect 5, wherein the resilient cantilever fingers are configured to flex radially outwardly beyond the second radial configuration to a maximum expanded configuration during insertion of the collar body over the valve head, and wherein the resilient cantilever fingers are configured to resiliently move from the maximum expanded configuration to the second radial configuration as the radial retention tabs fit into the outer circumferential groove.

Aspect 9. The coupling assembly of aspect 4, the collar further comprises at least one axial pin that projects from the central hub, and wherein the at least one axial pin is configured to fit within a pin opening defined by an axial end face of the valve head.

Aspect 10. The coupling assembly of aspect 9, wherein the at least one axial pin includes two or more pins.

Aspect 11. The coupling assembly of aspect 1, wherein the valve guide has a first port facing surface defining a spring groove, and wherein a valve spring for spring biasing the valve member to the closed position is captured between the valve head and the first port facing surface.

Aspect 12. The coupling assembly of aspect 6, wherein the seal is an elastomeric seal which is molded directly to the collar body.

Aspect 13. The coupling assembly of aspect 12, wherein the elastomeric seal is made of ethylene propylene rubber or neoprene.

Aspect 14. The coupling assembly of aspect 1, wherein the valve head is sized and configured such that when the collar is not attached to the valve head the valve head can pass through the valve seat.

Aspect 15. A method of assembly of a coupling assembly, the coupling assembly including a valve seat adjacent a valve port, the method comprising:
inserting a valve member through the valve port and the valve seat into an interior of the coupling assembly;
after insertion of the valve member into the interior of the valve, inserting a collar through the valve port and the valve seat and installing the collar on the valve member within the interior of the valve, wherein after installation of the collar on the valve member the collar prevents the valve member from passing through the valve seat and provides valve sealing with respect to the valve seat when the valve member is in a closed position.

Aspect 16. The method of aspect 15, wherein the collar is installed on a valve head of the valve member by a snap-fit connection.

Aspect 17. The method of aspect 16, wherein the collar includes resilient cantilever fingers that are radially compressed to pass the collar through the valve seat and that are radially expanded to snap the resilient cantilever fingers over the valve head.

Aspect 18. A coupling assembly comprising:
a main body forming a valve housing that extends along a housing axis, the valve housing including a first port end defining a first port and a second port end defining a second port, the valve housing defining a flow passage that extends through the valve housing from the first port to the second port, the valve housing further defining an internal valve seat;
a valve guide positioned within the flow passage;
a valve member supported by the valve guide within the valve housing, the valve member being moveable along the housing axis relative to the internal valve seat and the valve guide, the valve member including a valve head and a valve shaft, the valve shaft extending along the housing axis and being supported for movement along the housing axis by the valve guide; the valve member being moveable relative to the internal valve seat between an open position and a closed position, the valve member being spring biased toward the closed position;
a collar configured to mount to the valve head, the collar having a construction that is radially movable between a first radial configuration and a second radial configuration that is radially larger than the first radial configuration, the first radial configuration being configured to allow the collar to be inserted through the internal valve seat, the second radial configuration being configured to retain the collar on the valve head;
a valve head assembly including the valve head and the collar, the collar being configured such that when the collar is mounted on the valve head, the collar moves with the valve member relative to the internal valve seat between the open position and the closed position and prevents the valve head from moving through the valve seat, wherein when the valve member is in the closed position with the collar mounted on the valve head, the valve head assembly seals the internal valve seat preventing fluid flow through the internal valve seat, and wherein when the valve member is in the open position the valve head assembly with the collar mounted on the valve head fluid flow through the flow passage between the first port and the second port is allowed.

Aspect 19. The coupling assembly of aspect 18, wherein the main body defining the valve housing has a unitary seamless construction defining the first port, the second port, the valve seat and the flow passage.

Aspect 20. The coupling assembly of aspects 18 or 19, wherein the valve guide is unitary with the main body.

Aspect 21. The coupling assembly of any one of aspects 18-20, wherein the valve guide includes at least one arm, and wherein the at least one arm is integrally formed with the main body and the valve guide.

Aspect 22. The coupling assembly of any one of aspects 18-21, wherein the collar includes a collar body including a central hub and a plurality of circumferentially spaced-apart resilient cantilever fingers that project from the central hub, the resilient cantilever fingers having finger lengths that extend from base ends formed with the central hub to free ends, the resilient cantilever fingers being configured to resiliently flex along their lengths relative to the central hub to move the collar body between the first radial configuration and the second radial configuration.

Aspect 23. The coupling assembly of any one of aspects 18-22, wherein the valve head defines a first outer circumferential groove, wherein the resilient cantilever fingers include radial retention tabs at the free ends of the resilient cantilever fingers, and wherein the radial retention tabs fit within the first outer circumferential groove to retain the collar on the valve head.

Aspect 24. The coupling assembly of any one of aspects 18-23, wherein the valve head includes a seal disposed between within a second circumferential groove, and wherein the collar mounts on the valve head behind the seal.

Aspect 25. The coupling assembly of any one of aspects 18-24, wherein the seal is an elastomeric radial seal, and wherein the seal radially seals with a sealing surface of the valve seat.

Aspect 26. The coupling assembly of any one of aspects 18-25, wherein the seal is radially compressed to be fit through the sealing surface of the valve seat and expands to form a radial seal.

Aspect 27. The coupling assembly of any one of aspects 18-26, wherein the collar is positioned on an axial end face of the valve head facing the valve seat and wherein the collar includes a seal that mounts to the central hub and is carried with the collar body.

Aspect 28. The coupling assembly of any one of aspects 18-27, wherein the central hub defines a seal groove that extends circumferentially about the central hub, wherein the seal mounts within the seal groove, and wherein the seal is adapted to provide radial sealing with respect to the valve seat.

Aspect 29. The coupling assembly of any one of aspects 18-28, the collar further comprises at least one axial pin that projects from the central hub, and wherein the at least one axial pin is configured to fit within a pin opening defined by an axial end face of the valve head.

Aspect 30. The coupling assembly of any one of aspects 18-29, wherein the at least one axial pin includes two or more pins.

Aspect 31. The coupling assembly of any one of aspects 18-30, wherein the resilient cantilever fingers are configured to flex radially outwardly beyond the second radial configuration to a maximum expanded configuration during insertion of the collar body over the valve head, and wherein the resilient cantilever fingers are configured to resiliently move from the maximum expanded configuration to the second radial configuration as the radial retention tabs fit into the outer circumferential groove.

Aspect 32. The coupling assembly of any one of aspects 18-31, wherein the valve guide has a first port facing surface defining a spring groove, and wherein a valve spring for spring biasing the valve member to the closed position is captured between the valve head and the first port facing surface.

Aspect 33. The coupling assembly of any one of aspects 18-32, wherein the valve head is sized and configured such that when the collar is not attached to the valve head the valve head can pass through the valve seat.

Aspect 34. A method of assembly of a coupling assembly, the valve including a valve seat adjacent a valve port, the method comprising:
inserting a valve member through the valve port and the valve seat into an interior of the valve;
inserting a collar through the valve port and the valve seat and installing the collar on the valve member within the interior of the valve, wherein after installation of the collar on the valve member the collar prevents the valve member from passing through the valve seat and provides valve sealing with respect to the valve seat when the valve member is in a closed position.

Aspect 35. The method of aspect 34, wherein the collar is installed on a valve head of the valve member by a snap-fit connection.

Aspect 36. The method of aspects 34 or 35, wherein the collar includes resilient cantilever fingers that are radially compressed to pass the collar through the valve seat and that are radially expanded to snap the resilient cantilever fingers over the valve head.

Aspect 37. The method of claim any one of aspects 34-36, wherein the seal is an elastomeric radial seal, wherein the seal radially seals with a scaling surface of the valve seat, wherein the seal is radially compressed to be fit through a scaling surface of the valve seat and expands to form a radial seal.

What is claimed is:

1. A coupling assembly comprising:
a main body forming a valve housing that extends along a housing axis, the valve housing including a first port end defining a first port and a second port end defining a second port, the valve housing defining a flow passage that extends through the valve housing from the first port to the second port, the valve housing further defining an internal valve seat;
a valve guide positioned within the flow passage;
a valve member supported by the valve guide within the valve housing, the valve member being moveable along the housing axis relative to the internal valve seat and the valve guide, the valve member including a valve head and a valve shaft, the valve shaft extending along the housing axis and being supported for movement along the housing axis by the valve guide; the valve member being moveable relative to the internal valve seat between an open position and a closed position, the valve member being spring biased toward the closed position;
a collar configured to mount to the valve head, the collar having a construction that is radially movable between a first radial configuration and a second radial configuration that is radially larger than the first radial configuration, the first radial configuration being configured to allow the collar to be inserted through the internal valve seat, the second radial configuration being configured to retain the collar on the valve head;
a valve head assembly including the valve head and the collar, the collar being configured such that when the collar is mounted on the valve head, the collar moves with the valve member relative to the internal valve seat between the open position and the closed position and prevents the valve head from moving through the valve seat, wherein when the valve member is in the closed position with the collar mounted on the valve head, the valve head assembly seals the internal valve seat preventing fluid flow through the internal valve seat, and wherein when the valve member is in the open position the valve head assembly with the collar mounted on the valve head fluid flow through the flow passage between the first port and the second port is allowed.

2. The coupling assembly of claim 1, wherein the main body defining the valve housing has a unitary seamless construction defining the first port, the second port, the valve seat and the flow passage.

3. The coupling assembly of claim 2, wherein the valve guide is unitary with the main body.

4. The coupling assembly of claim 3, wherein the valve guide includes at least one arm, and wherein the at least one arm is integrally formed with the main body and the valve guide.

5. The coupling assembly of claim 1, wherein the collar includes a collar body including a central hub and a plurality of circumferentially spaced-apart resilient cantilever fingers that project from the central hub, the resilient cantilever fingers having finger lengths that extend from base ends formed with the central hub to free ends, the resilient cantilever fingers being configured to resiliently flex along their lengths relative to the central hub to move the collar body between the first radial configuration and the second radial configuration.

6. The coupling assembly of claim 5, wherein the valve head defines a first outer circumferential groove, wherein the resilient cantilever fingers include radial retention tabs at the free ends of the resilient cantilever fingers, and wherein the radial retention tabs fit within the first outer circumferential groove to retain the collar on the valve head.

7. The coupling assembly of claim 6, wherein the valve head includes a seal disposed between within a second circumferential groove, and wherein the collar mounts on the valve head behind the seal.

8. The coupling assembly of claim 7, wherein the seal is an elastomeric radial seal, and wherein the seal radially seals with a sealing surface of the valve seat.

9. The coupling assembly of claim 8, wherein the seal is radially compressed to be fit through the sealing surface of the valve seat and expands to form a radial seal.

10. The coupling assembly of claim 6, wherein the collar is positioned on an axial end face of the valve head facing the valve seat and wherein the collar includes a seal that mounts to the central hub and is carried with the collar body.

11. The coupling assembly of claim 10, wherein the central hub defines a seal groove that extends circumferentially about the central hub, wherein the seal mounts within the seal groove, and wherein the seal is adapted to provide radial sealing with respect to the valve seat.

12. The coupling assembly of claim 10, the collar further comprises at least one axial pin that projects from the central hub, and wherein the at least one axial pin is configured to fit within a pin opening defined by the axial end face of the valve head.

13. The coupling assembly of claim 12, wherein the at least one axial pin includes two or more pins.

14. The coupling assembly of claim 6, wherein the resilient cantilever fingers are configured to flex radially outwardly beyond the second radial configuration to a maximum expanded configuration during insertion of the collar body over the valve head, and wherein the resilient cantilever fingers are configured to resiliently move from the maximum expanded configuration to the second radial configuration as the radial retention tabs fit into the first outer circumferential groove.

15. The coupling assembly of claim 1, wherein the valve guide has a first port facing surface defining a spring groove, and wherein a valve spring for spring biasing the valve member to the closed position is captured between the valve head and the first port facing surface.

16. The coupling assembly of claim 1, wherein the valve head is sized and configured such that when the collar is not attached to the valve head the valve head can pass through the valve seat.

17. A method of assembly of a coupling assembly, the coupling assembly including a valve seat adjacent a valve port, the method comprising:
attaching a seal to one of a valve member or a collar;
inserting the valve member through the valve port and the valve seat into an interior of the coupling assembly;
inserting the collar through the valve port and the valve seat and installing the collar on the valve member within the interior of the coupling assembly, and
wherein after installation of the collar on the valve member, the collar prevents the valve member from passing through the valve seat and provides valve sealing with respect to the valve seat when the valve member is in a closed position.

18. The method of claim 17, wherein the collar is installed on a valve head of the valve member by a snap-fit connection.

19. The method of claim 18, wherein the collar includes resilient cantilever fingers that are radially compressed to pass the collar through the valve seat and that are radially expanded to snap the resilient cantilever fingers over the valve head.

20. The method of claim 17, wherein the seal is an elastomeric radial seal, wherein the seal radially seals with a sealing surface of the valve seat, wherein the seal is radially compressed to be fit through the sealing surface of the valve seat and expands to form a radial seal.
